(19) United States
(12) Patent Application Publication
(10) Pub. No.: US 2011/0095486 A1
(43) Pub. Date: Apr. 28, 2011

(54) OIL SEAL

(75) Inventor: Takehiro Nakagawa, Fukushima (JP)

(73) Assignee: NOK CORPORATION, Tokyo (JP)

(21) Appl. No.: 12/673,126

(22) PCT Filed: Aug. 27, 2008
(86) PCT No.: PCT/JP2008/065242

§ 371 Date: Feb. 11, 2010

(30) Foreign Application Priority Data
Sep. 20, 2007 (JP) 2007-243515

(51) Int. Cl. F16J 15/32

(52) U.S. Cl. 277/549

(57) ABSTRACT

Ridge and groove sections (24) having first slope surfaces (24a) and second slope surfaces (24b) are formed at a predetermined circumferential pitch on at least either of a slide seal surface (21) and an atmosphere-side conical surface (23) of a seal lip (2), the first slope surfaces (24a) slope at a gentle gradient in the direction of narrowing gaps between the first slope surfaces (24a) and the outer peripheral surface of a rotation body (10) toward the rotation direction of the rotation body (10), the second slope surfaces (24b) rise at a steeper gradient than the first slope surface (24a) from narrow gap portions, and a part of sealed fluid introduced into the gaps enters like a wedge toward the narrow gap portions as the rotation body (10) rotates, to generate dynamic pressure, and forms a thick fluid lubrication film to reduce slide resistance.

### CROSS-REFERENCE TO RELATED APPLICATIONS

This is a national phase of the International Application No. PCT/JP2008/065242 filed on Aug. 27, 2008 and published in the Japanese language. This application claims the benefit of Japanese Application No. 2007-243515, filed on Sep. 20, 2007. The disclosures of the above applications are incorporated herein by reference.

### BACKGROUND OF THE INVENTION

1. Field of the Invention

The present invention relates to an oil seal for sealing an outer periphery of a rotation body with a seal lip. The rotation body is used in an automobile, a general-use machine, an industrial machine, and the like.

2. Description of the Conventional Art

The patent document 1 discusses a conventional technique of an oil seal.

Reference is made to Japanese Patent Application Laid-Open No. 2005-282841.

FIG. 7 is a one-side sectional view of a conventional oil seal having a configuration similar to the configuration of the patent document 1, where the oil seal is cut at a plane passing an axis of the oil seal. The oil seal includes a seal lip 100 made of a rubber-like elastic material. The seal lip 100 includes a sealing space-side conical surface 102 and an atmosphere-side conical surface 103 on the inner peripheral surface thereof. These conical surfaces are bounded on a lip edge 101 having the smallest diameter. The sealing space-side conical surface 102 has a diameter becoming larger toward the side of the sealing space A, and the atmosphere-side conical surface 103 has a diameter becoming larger toward the side of the atmosphere B. The atmosphere-side conical surface 103 includes many screw ridges 104 having a ship bottom shape and having a height gradually increasing toward the side of the atmosphere B on the side of the lip edge 101. A garter spring 105 is provided for compensating fastening force of the seal lip 100 with respect to a rotary shaft 200.

The oil seal performs a shaft sealing function by a way that the lip edge 101 in the seal lip 100 is slidably close contacted with an outer peripheral surface of the rotary shaft 200 to prevent leakage of fluid to be sealed (e.g., oil) in the sealing space A through a shaft periphery toward the atmosphere B side. More particularly, screw ridges 104, 104, . . . perform a screw pumping effect in accordance with rotation of the rotary shaft 200, that is, push and return the fluid to be sealed, which tends to leak through the shaft periphery toward the atmosphere B side, back to the sealing space A side. Therefore, the oil seal has excellent sealing property.

In such a kind of oil seal, when reduction of sliding torque and sliding heat generation are attempted, a means of reducing fastening force with respect to the rotary shaft 200 by decreasing a cross section of the seal lip 100, a means of changing a material of the seal lip 100 to a low friction material, or a means of coating a low friction material on the surface of the seal lip 100 is adopted.

However, in the means of reducing fastening force with respect to the rotary shaft 200 by decreasing the cross section of the seal lip 100, rigidity of the seal lip 100 decreases so that there occurs a problem that handling property is lowered. For example, the garter spring 105 easily falls, or the seal lip 100 is easily curled up when fitting to the rotary shaft 200. Further, the means of changing a material to the low friction material and the means of applying a surface treatment to make friction low have problems that sealing property is badly affected and forming property comes to be difficult.

### SUMMARY OF THE INVENTION

### Problems to be Solved by the Invention

The present invention is to solve the aforementioned problems, and is directed to an oil seal in which sliding torque and sliding heat generation can be reduced without decreasing a cross section of a seal lip, using a low friction material, or using a like means.

### Means for Solving the Problem

As for a means for effectively solving the aforementioned problems, an oil seal according to the first aspect includes a slide seal surface and an atmosphere-side conical surface on an inner peripheral surface of a seal lip. The slide seal surface is in slidably close contact with an outer peripheral surface of a rotation body, and the atmosphere-side conical surface has a diameter becoming larger toward the atmosphere side from the slide seal surface. Ridge and groove sections are formed at a predetermined circumferential pitch on at least either of the slide seal surface and the atmosphere-side conical surface. Each of the ridge and groove sections has a first slope surface and a second slope surface. The first slope surface slopes at a relatively gentle gradient in the direction of narrowing a gap between the first slope surface and the outer peripheral surface of the rotation body toward the rotation direction of the rotation body. The second slope surface rises at a relatively steeper gradient than the first slope surface from a portion where the gap narrows.

According to this configuration, a part of the fluid to be sealed, which is introduced into the gap by the ridge and groove section from a portion between the slide seal surface of the seal lip and the outer peripheral surface of the rotation body enters like a wedge toward a portion where the gap is narrowed by the first slope surface in each of the ridge and groove sections according to rotation of the rotation body so as to generate dynamic pressure. This forms a thick fluid lubrication film to reduce sliding resistance between the seal lip and the outer peripheral surface of the rotation body.

As for an oil seal according to the second aspect, the ridge and groove sections described in the first aspect slope with respect to the rotation direction, in the direction of feeding the fluid on the outer periphery of the rotation body to the sealing space side from the atmosphere side by rotation of the rotation body.

According to this configuration, the ridge and groove sections perform a screw pumping effect when the rotation body is rotated to push and return the fluid to be sealed, which tends to leak from the sealing space toward the atmosphere side through the portion between the slide seal surface of the seal lip and the outer peripheral surface of the rotation body, back to the sealing space side. Thus, the sealing property increases. Further, a fluid lubrication function increases more by a cooperation of the screw pumping effect and the wedge effect of the fluid induced by the first slope of each of the ridge and groove sections.

### Effect of the Invention

The oil seal according to the first aspect increases the fluid lubrication effect by the wedge effect generated in the ridge and groove sections formed on the atmosphere-side conical surface. Thus, the sliding torque can decrease, and the sliding heat generation can decrease.

The oil seal according to the second aspect increases the sealing property by the screw pumping effect of pushing and returning the fluid to be sealed toward the sealing space side. In addition, the wedge effect of the fluid, which is induced by the first slope of each of the ridge and groove sections, cooperates with the screw pumping effect and increases more the effect for decreasing the sliding torque and the effect for decreasing the sliding heat.

### BRIEF EXPLANATION OF DRAWINGS

FIG. 1 is a one-side sectional view illustrating a first embodiment of an oil seal according to the present invention by cutting the oil seal at a plane passing an axis of the oil seal.

FIG. 2 is a view for illustrating a shape of ridge and groove sections of the seal lip and a function of the ridge and groove sections according to the first embodiment.

FIG. 3 is a view illustrating an example of a change of a shape of a ridge and groove sections of a seal lip and a function of the ridge and the groove sections.

FIG. 4 is a one-side sectional view illustrating another embodiment of an oil seal according to the present invention by cutting the oil seal at a plane passing an axis of the oil seal.

FIG. 5 is a one-side sectional view illustrating yet another embodiment of an oil seal according to the present invention by cutting the oil seal at a plane passing an axis of the oil seal.

FIG. 6 is a one-side sectional view illustrating yet another embodiment of an oil seal according to the present invention by cutting the oil seal at a plane passing an axis of the oil seal.

FIG. 7 is a one-side sectional view illustrating a convention oil seal by cutting the oil seal at a plane passing an axis of the oil seal.

### DETAILED DESCRIPTION OF PREFERRED EMBODIMENT

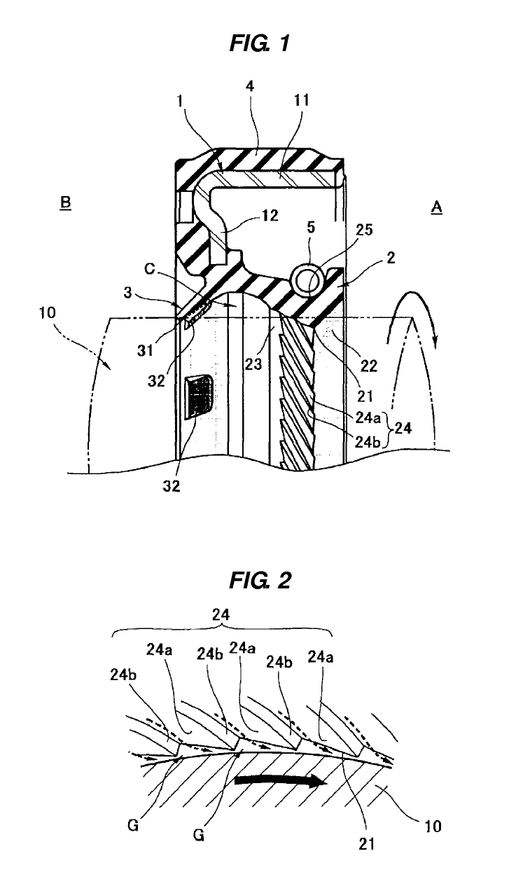

Preferred embodiments of an oil seal according to the present invention will be described below with reference to the drawings. FIG. 1 is a one-side sectional view illustrating the first embodiment of an oil seal according to the present invention by cutting the oil seal at a plane passing an axis of the oil seal. FIG. 2 is a view for illustrating a shape of ridge and groove sections of the seal lip, and a function of the ridge and groove sections according to the first embodiment.

An oil seal illustrated in FIG. 1 includes a metal ring 1 including a seal lip 2, dust lip 3, and a fixing seal section 4, which are provided integrally. The seal lip 2, the dust lip 3, and the fixing seal section 4 on the outer peripheral side of the dust lip 3 are made of a rubber-like elastic material, and are continuous to each other. Further, a garter spring 5 is mounted on the outer peripheral surface near a top end of the seal lip 2.

The metal ring 1 is a press-formed product from a steel plate, or the like. The metal ring 1 includes an outer peripheral cylindrical section 11, and an inward flange section 12 extending to the inner peripheral side from an end section of the outer peripheral cylindrical section 11 which is on the atmosphere B side in a mounting state.

The seal lip 2 extends from an inner peripheral position of the inward flange section 12 of the metal ring 1 in the direction toward the sealing space A side in a mounting state. The seal lip 2 includes a lip edge 21, a sealing space-side conical surface 22, and an atmosphere-side conical surface 23 on an inner periphery near a top end of the seal lip 2. The lip edge 21 has a chevron-shaped cross section and is in slidably close contact with the outer peripheral surface of the rotary shaft 10. The sealing space-side conical surface 22 has a diameter becoming larger toward the sealing space A side, and the atmosphere-side conical surface 23 has a diameter becoming larger toward the atmosphere B side. The sealing space-side conical surface 22 and the atmosphere-side conical surface 23 are bounded on the lip edge 21. In this case, the lip edge 21 corresponds to the slide seal surface described in claim 1, and the rotary shaft 10 corresponds to the rotation body described in claim 1.

The atmosphere-side conical surface 23 in the seal lip 2 includes many ridge and groove sections 24 formed at a predetermined circumferential pitch, and one end of each of the ridge and groove sections 24 reaches the lip edge 21. As clearly illustrated in FIG. 2, each of the ridge and groove sections 24 includes a first slope surface 24a and a second slope surface 24b. The first slope surface 24a slopes at a relatively gentle gradient in the direction that a gap G between the first slope surface 24a and the outer peripheral surface of the rotary shaft 10 narrows toward the rotation direction of the rotary shaft 10 as illustrated with a bold arrow in FIG. 2. The second slope surface 24b rises at a relatively steeper gradient than the first slope surface 24a from a portion where the gap G narrows most.

Further, the ridge and groove sections 24 extend at a predetermined sloping angle with respect to the rotation direction and in such a direction that a screw pumping effect to feed fluid co-rotating on the outer periphery of the rotary shaft 10 toward the lip edge 21 side is generated when the rotary shaft 10 rotates in the direction as illustrated with a bold arrow in FIG. 1 or 2.

The dust lip 3 extends in a conically cylindrical shape from the inner peripheral position of the inward flange section 12 of the metal ring 1 toward the side opposite to the seal lip 2 (the direction to be the atmosphere B side in a mounting state). A top end section 31 of the dust lip 3 is opposed and close to the outer peripheral surface of the rotary shaft 10. Further, a plurality of ribs 32 are formed on the inner peripheral surface on the seal lip 2 side from the top end section 31 in the dust lip 3 at a predetermined circumferential pitch. When an annular space C formed with the seal lip 2 and the dust lip 3 on the outer periphery of the rotary shaft 10 has negative pressure, the dust lip 3 is deformed by receiving the negative pressure, and the ribs 32 comes to be in contact with the outer peripheral surface of the rotary shaft 10, and thus supports the top end section 31 of the dust lip 3 so as to slightly uplift the top end section 31 from the outer peripheral surface of the rotary shaft 10.

The fixing seal section 4 is made of a rubber-like elastic material continued with the seal lip 2 and the dust lip 3, and the rubber-like elastic material rounds from the side opposite to the seal lip 2 in the inward flange section 12 of the metal ring 1 (the atmosphere B side in a mounting state) toward the outer peripheral side of the outer peripheral cylindrical section 11.

The fixing seal section 4 is tightly fitted and fixed on the inner peripheral surface of a shaft hole housing not illustrated, in a state of being properly compressed in a radial direction.

The garter spring 5 is made of an annularly connected metallic coil spring, and is fitted to an annular groove 25 formed on the outer peripheral surface near the top end in the seal lip 2.

In the oil seal having the aforementioned configuration, the seal lip 2 is pressed into and assembled to the inner peripheral surface of the shaft hole housing not-illustrated, and the seal lip 2 directs toward the sealing space A side. The lip edge 21 in the seal lip 2 is in slidably close contact with the outer peripheral surface of the rotary shaft 10. Therefore, seal lip 2 can prevent oil to be sealed in the sealing space A from leaking toward the atmosphere B side through the shaft periphery. The dust lip 3 can prevent dusts on the atmosphere B side from invading to the sealing space A.

The ridge and groove sections 24 form many fine gaps G between the lip edge 21 of the seal lip 2 and the outer peripheral surface of the rotary shaft 10. A part of the oil to be sealed, which tends to leak from the sealing space A side toward the atmosphere B side, is introduced into the gaps G. Further, if the rotary shaft 10 rotates in the clockwise direction as illustrated with the bold arrow in FIG. 2, the oil to be sealed introduced in each of the gaps G co-rotates with rotation of the rotary shaft 10, enters like a wedge toward a portion where the gaps G are narrowed by the first slope surfaces 24a of the ridge and groove sections 24, and thus generates dynamic pressure.

In addition, the oil to be sealed co-rotating in accordance with rotation of the rotary shaft 10 on the outer periphery of the rotary shaft 10 passes from the most narrowed portions of the gaps G formed by the first slope surfaces 24a to portions where the gaps G are expanded by the second slope surfaces 24b. However, since the second slope surfaces 24b rise at a steeper gradient than the first slope surfaces 24a, an inverted wedge effect, which sucks out the oil to be sealed from the most narrowed portion of the gaps G and decreases dynamic pressure, can be suppressed. Therefore, a thick fluid lubrication film is formed between the lip edge 21 and the outer peripheral surface of the rotary shaft 10 by the dynamic pressure of the oil to be sealed which enters toward the portions where the gaps G are narrowed by the first slope surfaces 24a sloping at a gentle gradient. Thus, the sliding resistance of the seal lip 2 with respect to the outer peripheral surface of the rotary shaft 10 decreases, and the sliding torque and the sliding heat generation can be reduced effectively.

Further, the ridge and groove sections 24 have a predetermined slope angle with respect to the rotation direction of the rotary shaft 10, and thus perform the screw pumping effect of feeding the fluid co-rotating on the outer periphery of the rotary shaft 10 toward the lip edge 21 side. Thus, ridge and groove sections 24 can effectively prevent the oil to be sealed from leaking to the atmosphere B side. Further, since the ridge and groove sections 24 are formed on the atmosphere-side conical surface 23, the gaps G between the ridge and groove sections 24 and the outer peripheral surface of the rotary shaft 10 gradually narrow toward the lip edge 21 side. Therefore, as illustrated with a broken line arrow in FIG. 2, the screw pumping effect makes the oil to be sealed enter into the narrowed portions on the lip edge 21 side. Thus, by cooperating with the aforementioned wedge effect induced by the first slope surface 24a, the screw pumping effect can increases more the liquid lubrication function, and can greatly decrease the sliding torque and the sliding heat generation.

In addition, the screw pumping effect induced by the ridge and groove sections 24 sucks out air in the space C formed on the outer periphery of the rotary shaft 10 by the seal lip 2 and the dust lip 3. Thus, the inside of the space C comes to be negative pressure. Therefore, an atmospheric pressure difference between the space C side and the atmosphere B side makes the dust lip 3 to be deformed and displaced toward the inner peripheral side. However, since the dust lip 3 is deformed, the plurality of the ribs 32 comes to be in contact with the outer peripheral surface of the rotary shaft 10, and thus support the top end section 31 of the dust lip 3 so as to slightly uplift the top end section 31 from the outer peripheral surface of the rotary shaft 10. Thus, the deformed dust lip 3 allows air to flow into the space C from the atmosphere B side. As a result, the atmospheric pressure difference between the space C side and the atmosphere B side does not increase. Therefore, the dust lip 3 can be prevented from being in entirely contact with the outer peripheral surface of the rotary shaft 10 and increasing the sliding torque and the sliding heat generation. Further, the screw pumping effect of the ridge and groove sections 24 is not hindered.

Further, when the rotation of the rotary shaft 10 stops, the wedge effect and the screw pumping effect as mentioned above does not work, and the lip edge 21 is in close contact with the outer peripheral surface of the rotary shaft 10. Thus, the fluid does not leak.

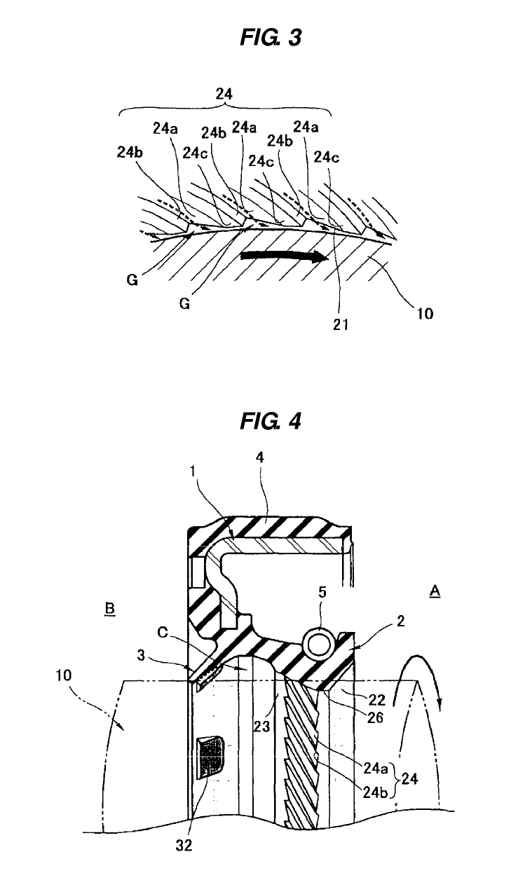

Next, FIG. 3 illustrates an example of the change in shape of ridge and groove sections of a seal lip and a function of the ridge and groove sections in the present invention. This second embodiment is different from the first embodiment in the point that a ridge section 24c between the first slope surface 24a of each of the ridge and groove sections 24 and the second slope surface 24b is formed to be flat in a cross section which orthogonally crosses the axis. That is, the ridge section 24c is formed to have conical surface continued with the atmosphere-side conical surface 23 illustrated in FIG. 1. The other configurations in the second embodiment are similar to those in the first embodiment.

Therefore, the second embodiment can realize a similar effect to that of the first embodiment.

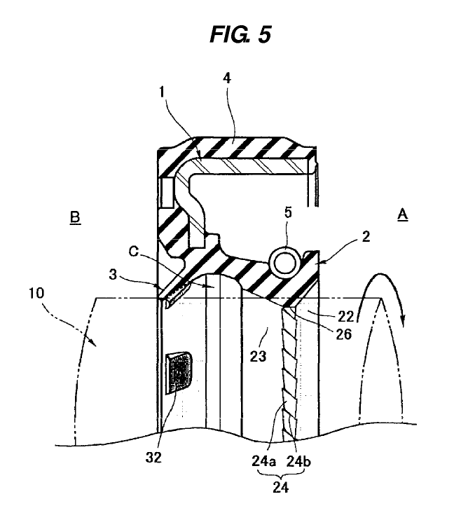

FIGS. 4, 5 and 6 are one-side sectional views illustrating other embodiments of an oil seal according to the present invention by cutting the oil seal at a plane passing an axis of the oil seal. These embodiments are different from the first embodiment in the point that the slide seal surface of the seal lip 2 in slidably close contact with the outer peripheral surface of the rotary shaft 10 is formed to be a cylindrical surface seal surface 26 instead of the lip edge 21 as in FIG. 1. Other configurations of these embodiments are similar to those in FIG. 1.

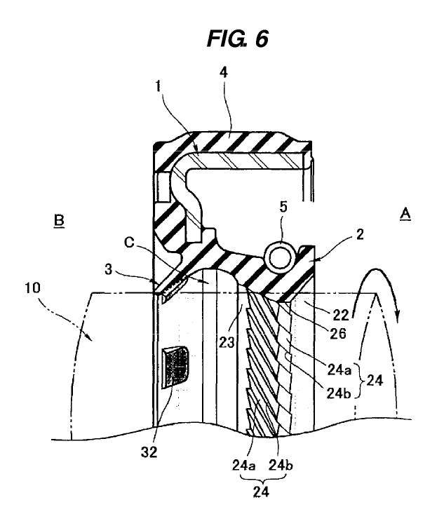

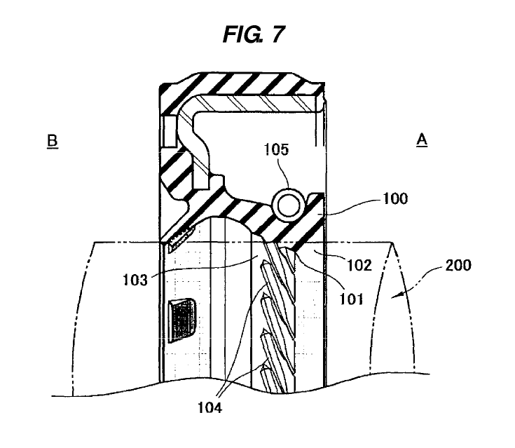

In the embodiment illustrated in FIG. 4 among those embodiments, the ridge and groove sections 24 are formed at a predetermined circumferential pitch on the atmosphere-side conical surface 23 in the seal lip 2. In the embodiment illustrated in FIG. 5, the ridge and groove sections 24 are formed at a predetermined circumferential pitch on the cylindrical surface seal surface 26. In the embodiment illustrated in FIG. 6, the ridge and groove sections 24 are formed at a predetermined circumferential pitch on both the atmosphere-side conical surface 23 and the cylindrical surface seal surface 26 continuously to each other.

In these embodiments, each of the ridge and groove sections 24 includes the first slope surface 24a and the second slope surface 24b similar to the first embodiment. The first slope surface 24a slopes at a relatively gentle gradient in the direction that the gap between the first slope surface 24a and the outer peripheral surface of the rotary shaft 10 narrows toward the rotation direction of the rotary shaft 10. The second slope surface 24b rises at a relatively steeper gradient than the first slope surface 24a from the portion where the gap narrows most. In addition, each of the ridge and groove sections 24 extends in the direction that the screw pumping effect of feeding the fluid to the sealing space A side according to rotation of the rotary shaft 10 is induced, having a predetermined sloping angle with respect to the rotation direction. Therefore, these embodiments can realize a similar effect to that of the first embodiment.

1. An oil seal comprising a slide seal surface and an atmosphere-side conical surface on an inner peripheral surface of a seal lip, wherein the slide seal surface is in slidably close contact with an outer peripheral surface of a rotation body,
wherein the atmosphere-side conical surface has a diameter becoming larger toward the atmosphere side from the slide seal surface,
wherein ridge and groove sections are formed at a predetermined circumferential pitch on at least either of the slide seal surface and the atmosphere-side conical surface, wherein each of the ridge and groove sections comprises a first slope surface sloping at a relatively gentle gradient in the direction of narrowing a gap between the first slope surface and the outer peripheral surface of the rotation body toward the rotation direction of the rotation body and a second slope surface rising at a relatively steeper gradient than the first slope surface from a portion where the gap narrows, and wherein the ridge and groove sections extends at a sloping angle with respect to the rotation direction and in the direction of feeding fluid on an outer periphery of the rotation body to the sealing space side from the atmosphere side by rotation of the rotation body.

2. (canceled)
